(19) United States
(12) Patent Application Publication
(10) Pub. No.: US 2021/0387899 A1
(43) Pub. Date: Dec. 16, 2021

(54) TRANSPARENT BETA-QUARTZ GLASS CERAMICS WITH A LOW LITHIUM CONTENT

(71) Applicant: Eurokera, Jouarre (FR)

(72) Inventors: Tiphaine Fevre, Paris (FR); Marie Comte, Fontenay Aux Roses (FR); Philippe Lehuede, Dammarie-Leslys (FR)

(21) Appl. No.: 17/290,929

(22) PCT Filed: Nov. 6, 2019
(86) PCT No.: PCT/EP2019/080433

§ 371 Date: May 3, 2021

(30) Foreign Application Priority Data
Nov. 9, 2018 (FR) 1860378

(51) Int. Cl. C03C 10/00; C03C 1/00; C03C 1/04; C03C 3/097; C03B 32/02

(52) U.S. Cl. CPC C03C 10/0027; C03C 10/0054; C03C 1/004; C03C 2204/00; C03C 3/097; C03B 32/02; C03C 1/04

(57) ABSTRACT

The present applicationprovides transparent glass-ceramics of lithium aluminosilicate type, of β-quartz, the composition of which contains a low content of lithium, articles constituted at least in part by said glass-ceramics, precursor glasses for said glass-ceramics, and also a method of preparing said articles. Said glass-ceramics have a composition, expressed in percentages by weight of oxide, containing63% to 67.5% of SiO₂; 18% to 21% of Al₂O₃; 2% to 2.9% of Li₂O; 0 to 1.5% of MgO; 1% to 3.2% of ZnO; 0 to 4% of BaO; 0 to 4% of SrO; 0 to 2% of CaO; 2% to 5% of TiO₂; 0 to 3% of ZrO₂; 0 to 1% of Na₂O; 0 to 1% of K₂O; 0 to 5% of P₂O₅; with (0.74 MgO+0.19 BaO+0.29 SrO+0.53 CaO+0.48 Na₂O+0.32 K₂O)/Li₂O<0.9; optionally up to 2% of at least one fining agent; and optionally up to 2% of at least one coloring agent.

The context of the present application is that of transparent low expansion glass-ceramics of lithium aluminosilicate (LAS) type containing a solid solution of β-quartz as the main crystalline phase. The present application relates more particularly to:
transparent glass-ceramics of lithium aluminosilicate (LAS) type containing a solid solution of β-quartz as the main crystalline phase and having a low lithium content; said glass-ceramics being materials that are entirely suited to making cooktops associated with induction heating;
articles constituted, at least in part, of these glass-ceramics;
lithium aluminosilicate glasses, precursors of these glass-ceramics; and
a method of preparing these articles.

Transparent glass-ceramics—of the lithium aluminosilicate (LAS) type, containing a solid solution of β-quartz as the main crystalline phase—have been in existence for more than 20 years. They are described in numerous patent documents and in particular in patent U.S. Pat. No. 5,070,045 and patent application WO 2012/156444. They are used more particularly as the material for constituting cooktops, cooking utensils, microwave oven bottoms, fireplace windows, fireplace inserts, stove windows, oven doors (in particular for pyrolytic and catalytic ovens), and fire-windows.

In order to obtain such glass-ceramics (more precisely in order to eliminate inclusions of gas in the molten mass of precursor glass), conventional fining agents, As₂O₃ and/or Sb₂O₃ have been used for a long time. In view of the toxicity of those two compounds and of the ever more severe regulations that are in force, it is desired not to make use of these (toxic) fining agents any more in fabricating the precursor glass. For environmental considerations, it is also no longer desired to use halogens, such as F and Br, which can be substituted for said conventional fining agents As₂O₃ and Sb₂O₃, at least in part. SnO₂ has been proposed as a substitute fining agent (see in particular the teaching of patent documents U.S. Pat Nos. 6,846,760, 8,053,381, WO 2012/156444, U.S. Pat. Nos. 9,051,209, and 9,051,210). It is being used more and more. Nevertheless, at a similar fining temperature, it is found to be less effective than As₂O₃. In general manner, and thus most particularly in a context of using SnO₂ as a fining agent, it is advantageous to have (precursor) glasses with low viscosities at high temperature in order to facilitate fining.

Depending on the heating elements that are associated with such cooktops (radiant heating elements or induction heating elements), requirements concerning values for the (linear) coefficient of thermal expansion (CTE) of the material constituting said cooktops are more or less constraining:
plates used with radiant heating can be raised to temperatures as high as 725° C., and in order to be able to withstand the thermal shocks and the temperature gradients that occur within them, their CTE is low, generally lying in the range ±10×10⁻⁷ per kelvin (K⁻¹), preferably in the range ±3×10⁻⁷K⁻¹ from 25° C. to 700° C.; and

plates used with (conventional) induction heating are subjected to lower temperatures (temperatures that reach 450° C. only exceptionally, and generally no more than 400° C.). The thermal shocks to which they are subjected are thus less violent; the CTE of such cooktops can be higher.

There also exist plates associated with induction heating that make use of a new generation of induction heater, with infrared temperature sensors (such as pyrometers or thermopiles) aimed to control the temperature of the cooking utensils. By means of such sensors, the temperature of the plate is better controlled and does not exceed 300° C. Under such conditions, even greater CTE values can be entirely suitable. Nevertheless, it should be observed that such cooktops occupy a (narrow) top-of-range market segment.

The plates proposed in the present application are suitable for use with conventional induction heating; they withstand temperatures of 400° C., and exceptionally thermal shocks at 450° C.

For reasons of appearance, it is also desirable for plates, even when transparent, to mask the elements that are placed beneath them, such as induction coils, electric wiring, and circuits for controlling and monitoring the cooking appliance. An opacifier may be deposited on the bottom face of such a plate or the material from which it is constituted may be strongly colored. If this case, some minimum level of transmission must nevertheless be conserved so that displays can be seen, as a result of light emitted by light-emitting diodes (LEDs) placed under the plate.

Lithium is one of the main components of these glass-ceramics (of the lithium aluminosilicate (LAS) type, which are transparent and contain a solid solution of β-quartz as the main crystalline phase). At present, lithium is present in the composition of said glass-ceramics, generally at contents lying in the range 2.5% to 4.5% (see for example the teaching of patents U.S. Pat. Nos. 9,051,209 and 9,051,210), more generally at contents of 3.6% to 4.0%, by weight (expressed in terms of Li₂O). It is used essentially as an component of the solid solution of β-quartz. It makes it possible within the glass-ceramics to obtain CTE values that are low or even zero. It constitutes a particularly high performance melting agent for the precursor glass (its impact being observed most particularly on high temperature viscosity). At present, the supply of lithium is less reliable than it used to be. In any event, this element is becoming more expensive. The reason for this recent pressure on the availability and the price of lithium lies in the increasing demand for lithium for producing lithium batteries.

The prior art already described precursor glasses for glass-ceramics (of the lithium aluminosilicate (LAS) type, which are transparent and contain a solid solution of β-quartz as the main crystalline phase), together with the associated glass-ceramics, which present compositions having a greater or lesser lithium content. Thus:
patent U.S. Pat. No. 9,446,982 describes colored transparent glass-ceramics of lithium aluminosilicate (LAS) type containing a solid solution of β-quartz as the main crystalline phase and containing lithium contents (expressed in terms of Li₂O) that are in the range 2% to less than 3% by weight (at least 2% by weight, with reference to controlling crystallization), and magnesium contents (expressed in terms of MgO) lying in the range 1.56% to 3% by weight, with reference to the looked-for CTE value. For the glass-ceramics that are described, CTE values in the range 10×10⁻⁷K⁻¹ to 25×10⁻⁷K⁻¹, between ambient temperature and 700° C., are aimed, with reference to the technical problem of the compatibility of said glass-ceramics with their decoration;
patent application US 2015/0197444 describes transparent glass-ceramics of the lithium aluminosilicate (LAS) type containing a solid solution of β-quartz as the main crystalline phase and presenting a controlled transmission curve. The compositions described are free from As₂O₃ and Sb₂O₃ and they contain tin oxide (SnO₂) as fining agent. They generally contain 2.5% to 4.5% by weight of Li₂O. The example compositions contain high contents of Li₂O, lying in the range 3.55% to 3.80% by weight;
patent U.S. Pat. No. 9,018,113 describes colored transparent glass-ceramics presenting transmission curves that are optimized in the visible and infrared ranges and that are suitable for use as cooktops associated with induction heating. Their composition contains 1.5 wt. % to 4.2 wt. % Li₂O; specifically the example compositions all contain contents of Li₂O superior to 2.9 wt. %; and
patent application DE 10 2018 110 855 describes transparent glass-ceramics having a CTE of ±10×10⁻⁷K⁻¹ (from 20° C. to 700° C.), of composition containing 3.0 wt. % to 3.6 wt. % Li₂O (preferably in the range 3.2 wt. % to 3.6 wt. % of Li₂O), and V₂O₅ or MoO₃ as coloring agents.

In such a context, the inventors have found it appropriate to seek glass-ceramic compositions of low lithium content (maximum content 2.9% by weight of Li₂O); the glass-ceramics in question, transparent, of lithium aluminosilicate (LAS) type and containing a solid solution of β-quartz as the main crystalline phase, being entirely suitable as material for making cooktops usable with induction heating (conventional induction heating; said cooktops being subjected to temperatures that reach 450° C. only exceptionally, and generally no more than 400° C.). It was also most desirable:
for the precursor glasses of said glass-ceramics to present properties similar to those of precursor glasses for presently fabricated glass-ceramics so that the industrial process can be transposed easily; and
for said precursor glasses to be capable of being colored and most particularly of developing a black color while they are being cerammed, without a level of haze appearing that impedes good visibility of the red light emitted by light-emitting diodes (LEDs) arranged under cooktops.

Specifications for the glass-ceramics in question are set out below:
to present a CTE lying in the range ±14×10⁻⁷K⁻¹ between 25 and 450° C. (−14×10⁻⁷K⁻¹≤CTE_{(25-450° C.)}≤+14×10⁻⁷K⁻¹), advantageously lying in the range ±10×10⁻⁷K⁻¹ (−10×10⁻⁷K⁻¹≤CTE_{(25-450° C.)}≤+10×10⁻⁷K⁻¹), CTE_{(25-450° C.)} which is thus acceptable for use with conventional induction heating (it can be understood that said CTE_{(25-450° C.)} is less than or equal to 14×10⁻⁷K⁻¹, advantageously less than or equal to 10×10⁻⁷K⁻¹) and also, opportunely, a CTE lying in the range ±14×10⁻⁷K⁻¹ between 25 and 700° C. (−14×10⁻⁷K⁻¹≤CTE_{(25-700° C.)}≤+14×10⁻⁷K⁻¹),
thus to be transparent (even if they are usually strongly colored): at the intended utilization thickness (cooktops typically have a thickness of 1 millimeter (mm) to 8 mm, more generally lying in the range 2 mm to 5 mm and often having a thickness of 4 mm), said glass-ceramics need to present integrated transmission, TL or Y (%) greater than or equal to 1% and a diffusion percentage (diffusion or haze (%)) less than 2%. By way of example, these measurements may be performed using a spectrometer having an integrating sphere. On the basis of these measurements, the integrated transmission (TL or Y (%)) in the visible range (from 380 nanometers (nm) to 780 nm) and the diffusion percentage (diffusion or haze (%)) are calculated using the standard ASTM D 1003-13 (under D65 illuminant with 2° observer); and
to have a precursor glass that possesses advantageous properties, indeed the same advantageous properties than those of glasses containing a higher Li₂O content (prior art glass-ceramic precursors); i.e.:
said precursor glass must present a low liquidus temperature (<1400° C.) and a high viscosity at the liquidus (>400 pascal seconds (Pa.s), preferably >700 Pa.s), thereby facilitating forming; and/or, advantageously and
said precursor glass must possess a low viscosity at high temperature (T_{30 Pa.s}≤1640° C., advantageously ≤1630° C.), thereby facilitating fining.

It is also highly appropriate for said precursor glass to be capable of being transformed into glass-ceramic in a short length of time (<3 hours (hr)), preferably in a very short length of time (<1 hr), and/or, advantageously and, for said precursor glass to present electrical resistivity at a viscosity of 30 Pa.s that is less than 50 ohm-centimeters (Ω.cm) (and preferably less than 20 Ω.cm). The person skilled in the art will understand (in the light of the composition set out below for the glass-ceramics of the present application) that obtaining these last two properties, which are advantageously required for the precursor glass, does not present any particular difficulty.

The inventors have established that glass-ceramics (of lithium aluminosilicate (LAS) type, containing a solid solution of β-quartz as the main crystalline phase) exist with a composition that contains a low lithium content (at most 2.9% by weight of Li₂O) and that satisfy the above specifications. Said glass-ceramics constitute the first aspect of the present application. In characteristic manner, these glass-ceramics present the following composition, expressed in percentages by weight of oxides:
63% to 67.5% of SiO₂;
18% to 21% of Al₂O₃;
2% to 2.9% of Li₂O;
0 to 1.5% of MgO;
1% to 3.2% of ZnO;
0 to 4% of BaO;
0 to 4% of SrO;
0 to 2% of CaO;
2% to 5% of TiO₂;
0 to 3% of ZrO₂;
0 to 1% of Na₂O;
0 to 1% of K₂O;
0 to 5% of P₂O₅;
with (0.74 MgO+0.19 BaO+0.29 SrO+0.53 CaO+0.48 Na₂O+0.32 K₂O)/Li₂O<0.9;
   optionally up to 2% of at least one fining agent; and
   optionally up to 2% of at least one coloring agent.

The following may be specified concerning each of the components involved (or potentially involved) at the specified contents in the composition here above specified (the extreme values of each indicated range (both main ranges and also preferred, advantageous “sub-ranges”: see above and below) being included in said ranges). It should be recalled that the percentages given are percentages by weight.
Si₂ (63%-67.5%): the content of SiO₂ (≥63%) must be suitable for obtaining a precursor glass (for the glass-ceramic) that is sufficiently viscous to guarantee a minimum value of the liquidus viscosity. The content of SiO₂ is limited to 67.5%, insofar as the greater the content of SiO₂, the greater the high-temperature viscosity of the glass, and thus the glass is more difficult to melt. Comparative example A illustrates this limitation. In preferred manner, the SiO₂ content lies in the range 65% to 67% (bounds included).
P₂O₅ (0-5%): this compound is optionally present. To be effective, when present, it is generally present at at least 0.5%. As a substitute for SiO₂, P₂O₅ serves to reduce the liquidus temperature, in particular when the ZnO content is large (i.e. >2.5%). This point is illustrated by comparing Example 4 (with 2.11% P₂O₅) and Example 11 (no P₂O₅ (0.05%)). In advantageous manner, to obtain a significant effect on the liquidus temperature, P₂O₅, present, is present at a content lying in the range 1% to 5% (bounds included). In a very advantageous manner, P₂O₅, present, is present at a content lying in the range 1% to 3% (bounds included). Incidentally, it may be observed that in the absence of any added P₂O₅, some may be found in the composition of the glass (as an impurity in at least one of the raw materials used or in the cullet of glass and/or glass-ceramic used) in trace form, generally at a maximum content of 1000 parts per million (ppm) (0.1%).
Al₂O₃ (18%-21%): the presence of ZnO in the quantities specified (quite large) makes controlling the content of Al₂O₃ critical in order to limit devitrification phenomena. Excessive quantities of Al₂O₃ (>21%) make the composition more likely to devitrify (into mullite crystals or other crystals), which is not desirable. Conversely, quantities of Al₂O₂ that are too small (<18%) are unfavorable to nucleation and to the formation of small β-quartz crystals. An Al₂O₃ content in the range 18% to 20% (bounds included) is advantageous.
Li₂O (2%-2.9%): the inventors have shown that it is possible to obtain glass-ceramics satisfying the requirements of the above specifications while limiting the content of Li₂O to 2.9% (and thus substantially limiting said content). Said content is advantageously no more than 2.85%, said content is very advantageously no more than 2.80%. A minimum content of 2% is nevertheless necessary in order to be able to retain satisfactory devitrification and CTE characteristics. That is why it is necessary to satisfy the condition: (0.74 MgO+0.19 BaO+0.29 SrO+0.53 CaO+0.48 Na₂O+0.32 K₂O)/Li₂O<0.9. This condition is illustrated in comparative example E. The minimum content is advantageously 2.2%. Thus a Li₂O content in the range 2.2% to 2.85% (bounds included) is preferred; a Li₂O content in the range 2.2% to 2.80% (bounds included) is most particularly preferred.
MgO (0-1.5%) and ZnO (1%-3.2%): the inventors have obtained the looked-for results by making use, at the specified quantities, of ZnO and also optionally of MgO, as partial substitute(s) for Li₂O (present in the range 2% to 2.9%).
MgO (0-1.5%): this compound is optionally present. In order to be effective, when present, it is generally present at at least 0.1%. This compound decreases high-temperature viscosity of the precursor glass. It forms part of the solid solution of β-quartz. It has less impact on devitrification than ZnO (see below) but it greatly increases the CTE of the glass-ceramic (as shown in comparative example C). That is why its content, when present, is limited to 1.5%. When present, it is advantageously present in the range 0.1% to 1.4%, in particular in the range 0.1% to 1.37%, more particularly in the range 0.1% to 1.35%, still more particularly in the range 0.1% to 1.3%. In any event the following condition needs to be satisfied: (0.74 MgO+0.19 BaO+0.29 SrO+0.53 CaO+0.48 Na₂O+0.32 K₂O)/Li₂O<0.9.
ZnO (1%-3.2%): this compound also serves to diminish the high-temperature viscosity of the precursor glass and it also forms part of the solid solution of β-quartz. Compared with Li₂O, it increases the CTE of the glass-ceramic, but does so in moderate manner, which makes it possible to obtain glass-ceramics having CTEs less than 14×10⁻⁷K⁻¹ between 25 and 450° C. When present in too great a quantity, it leads to unacceptable devitrification (as illustrated in comparative example D). Advantageously, it is present in the range 1% to 3%. In the absence of P₂O₅, its content lies preferably in the range 1% to 2.5% (see above).
TiO₂ (2%-5%) and ZrO₂ (0-3%): ZrO₂ is advantageously present (but not necessarily). With reference to effectiveness, it should generally be present at at least 0.1%. These compounds, TiO₂ and ZrO₂ enable the precursor glass to nucleate and enable a transparent glass-ceramic to be formed. The combined presence of these two compounds enables nucleation to be optimized. Too great a content of TiO₂ makes it difficult to obtain a glass-ceramics that is transparent. TiO₂ is advantageously present at a content lying in the range 2% to 4% (bounds included), and very advantageously it is present at a content lying in the range 2% to 3% (bounds included). Too great a content of ZrO₂ leads to unacceptable devitification. ZrO₂ is advantageously present at a content lying in the range 0 to 1.5% (bounds included), very advantageously it is present at a content lying in the range 1% to 1.5% (bounds included).
BaO (0-4%), SrO (0-4%), CaO (0-2%), Na₂O (0-1%), and K₂O (0-1%): these compounds are optionally present. To be effective, each of them, when present, is generally present at at least 1000 ppm (0.1%). These compounds remain in the vitreous phase of the glass-ceramic. They reduce the high-temperature viscosity of the precursor glass, they facilitate dissolution of ZrO₂ (when present), and they limit devitrification into mullite, but they increase the CTE of glass-ceramics. That is why the following condition needs to be satisfied:

(0.74 MgO+0.19 BaO+0.29 SrO+0.53 CaO+0.48 Na₂O+0.32 K₂O)/Li₂O<0.9.

It may be observed that SrO is generally not present in the form of added raw material. In such a context (no SrO present as added raw material), if SrO is present, it is present only as inevitable traces (<100 ppm), brought in as impurity with at least one of the raw materials used or within the cullet of glass and/or glass-ceramic used.
Fining agent(s): the composition of the glass-ceramics of the present application advantageously includes at least one fining agent such as As₂O₃, Sb₂O₃, SnO₂, CeO₂, a chloride, a fluoride, or a mixture thereof. Said at least one fining agent is present in an effective quantity (for performing chemical fining), which conventionally does not exceed 2% by weight. It is thus generally present in the range 0.05% to 2% by weight.
In preferred manner, for environmental reasons, fining is performed by using SnO₂, generally with 0.05% to 0.6% by weight of SnO₂, and more particularly with 0.15% to 0.4% by weight of SnO₂. Under such circumstances, the compositions of the glass-ceramics of the present application contain neither As₂O₃ nor Sb₂O₃, or they contain only inevitable traces of at least one of these toxic compounds (As₂O₃₊Sb₂O₃<1000 ppm). If traces of at least one of these compounds are present, they are present as contamination; by way of example, this may be due to the presence of recycled materials of the cullet type (derived from old glasses or glass-ceramics refined with these compounds) in the charge of vitrifiable raw materials. Under such circumstances, the presence of at least one other fining agent, such as CeO₂, a chloride, and/or a fluoride is not excluded, but SnO₂ is preferably used as the only fining agent.
It should be observed that the absence of an effective quantity of chemical fining agent(s), or indeed the absence of any chemical fining agent, is not completely to be excluded; fining can then be performed thermally. This non-excluded variant is nevertheless not preferred in any way.
   Coloring agent(s): the composition of the glass-ceramics advantageously includes at least one coloring agent. In the context of cooktops, it is appropriate to mask elements that are arranged under said cooktop. Said at least one coloring agent is present in an effective quantity (generally at least 0.01% by weight); it is conventionally present at at most 2% by weight, or indeed at most 1% by weight. Said at least one coloring agent is conventionally selected from oxides of transition elements (V₂O₅, CoO, Cr₂O₃, Fe₂O₃ (see below), NiO, . . . ) and of rare earths (Nd₂O₃, Er₂O₃, . . . ). In preferred manner, vanadium oxide V₂O₅ is used since said vanadium oxide leads to a low absorption (in particular in infra-red range) of the precursor glass, which is advantageous for melting. The absorption it makes possible is generated during the ceramming treatment (during which it is partially reduced). It is particularly advantageous to combine V₂O₅ with other coloring agents such as Cr₂O₃, CoO, or Fe₂O₃ (see below), since that enables transmission to be modulated. With reference to the requirements set out below (formulated for the utilization thickness, typically in the range 1 mm to 8 mm, more generally in the range 2 mm to 5 mm, and often 4 mm):
   having integrated transmission (TL) less than 10%, advantageously less than 4%, very advantageously less than 2,1%;
   while maintaining transmission:
   at 625 nm (T_{625 nm}) greater than 1%, thus making it possible to pass light from an LED emitting red light and placed under the cooktop for display purposes;
   at 950 nm (T_{950 nm}) lying in the range 50% to 75%, thus enabling infrared electronic control buttons to be used, which emit and receive at this wavelength;
the following combination of coloring agents has been found to be advantageous (% by weight of the total composition):

V₂O₅ 0.025%-0.200%

Fe₂O₃ 0.0095%-0.3200%

Cr₂O₃ 0.01%-0.04%.
Among the coloring agents Fe₂O₃ has a special place. It has an effect on color and it is indeed often present, at a greater or lesser quantity as an impurity (e.g. coming from the raw material). Nevertheless, it may also be added in order to adjust color. Its authorized presence “in large quantity” in the composition of glass-ceramics of the present application makes it possible to use raw materials that are less pure and thus often less expensive.

Concerning the condition that needs to be satisfied: the ratio (0.74 MgO+0.19 BaO+0.29 SrO+0.53 CaO+0.48 Na₂O+0.32 K₂O)/Li₂O<0.9, relating essentially to the CTE of the glass-ceramic, it will be understood that the compounds in the numerator sum are weighted as a function of their molar masses relative to the denominator reduced to one mole of Li₂O. It is actually advantageous for said ratio (0.74 MgO+0.19 BaO+0.29 SrO+0.53 CaO+0.48 Na₂O+0.32 K₂O)/Li₂O to be less than 0.7 ((0.74 MgO+0.19 BaO+0.29 SrO+0.53 CaO+0.48 Na₂O+0.32 K₂O)/Li₂O<0.7). For what purpose it may serve, we remind here that the oxide contents are given in weight percentages.

The above-identified ingredients involved, or potentially involved, in the composition of glass-ceramics of the present application (SiO₂, P₂O₅, Al₂O₃, Li₂O, MgO, ZnO, TiO₂, ZrO₂, BaO, SrO, CaO, Na₂O, K₂O, fining agent(s), and coloring agent(s)) can indeed represent 100% by weight of the composition of glass-ceramics of the present application, but, a priori, the presence of at least one other compound is not to be totally excluded, providing it is in a low quantity (generally less than or equal to 3% by weight) and does not substantially affect the properties of the glass-ceramics. In particular, the following compounds may be present, at a total content of less than or equal to 3% by weight, each of them being present at a content less than or equal to 2% by weight: B₂O₃, Nb₂O₅, Ta₂O₅, WO₃, and MoO₃. Concerning B₂O₃, it is thus potentially present (0-2%). When present, in order to be effective, more particularly to improve fusibility of the precursor glass, it is generally present at at least 0.5%. It is more generally present in the range 0.5% to 1.5%. Nevertheless, B₂O₃ is rarely present in practice as an added raw material, it being generally present only in the state of traces (at contents of less than 0.1%). Specifically, B₂O₃ favors ceramming into β-spodumene and the apparition of diffusion (or haze). Thus, the compositions of glass-ceramics of the present application are advantageously exempt from B₂O₃, with the exception of inevitable traces.

The above-identified ingredients involved, or potentially involved, in the composition of glass-ceramics of the present application (SiO₂, P₂O₅, Al₂O₃, Li₂O, MgO, ZnO, TiO₂, ZrO₂, BaO, SrO, CaO, Na₂O, K₂O, fining agent(s), and coloring agent(s)), thus represent at least 97% by weight, or indeed 98% by weight, or at least 99% by weight, or even 100% by weight (see above) of the composition of glass-ceramics of the present application.

The glass-ceramics of the present application thus contain SiO₂, Al₂O₃, Li₂O, ZnO, and MgO as essential components for the solid solution of β-quartz (see below). This solid solution of β-quartz represents the main crystalline phase. This solid solution of β-quartz generally represents more than 80% by weight of the total crystallized fraction. It generally represents more than 90% by weight of said total crystallized fraction. The size of the crystals is small (typically less than 70 nm), which enables the glass-ceramics to be transparent (integrated transmission≥1% and diffusion<2%).

The glass-ceramics of the present application contain about 10% to about 40% by weight of residual glass.

The glass-ceramics of the present application thus have a coefficient of thermal expansion lying in the range ±14×10⁻⁷K⁻¹, advantageously in the range ±10×10⁻⁷K⁻¹, between 25 and 450° C.; and, also advantageously, a coefficient of thermal expansion lying in the range ±14×10⁻⁷K⁻¹ between 25 and 700° C. (see above).

In a second aspect, the present application provides articles that are constituted at least in part of a glass-ceramic of the present application as described above. Said articles are optionally constituted in full of a glass-ceramic of the present application. Said articles advantageously consist in cooktops, which are a priori bulk colored (see above). Nevertheless, that is not the only application for which they can be used. In particular, they may constitute the material constituting cooking utensils, microwave oven bottoms, oven doors, whether colored or not. It will naturally be understood that the glass-ceramics of the present application are logically used in contexts that are compatible with their CTEs. Thus, cooktops according to the invention are strongly (adapted and) recommended for use with conventional induction heating elements.

In a third aspect, the present application provides aluminosilicate glasses that are precursors for the glass-ceramics of the present application, as described above. In characteristic manner, said glasses present a composition that makes it possible to obtain said glass-ceramics. Said glasses generally present a composition corresponding to that of said glass-ceramics, but the correspondence is not necessarily complete insofar as the person skilled in the art readily understands that the thermal treatments applied to such glasses for obtaining glass-ceramics are likely to have some effect on the composition of the material. The glasses of the present application are obtained in conventional manner by melting a vitrifiable charge of raw materials (raw materials making them up being present in the appropriate proportions). Nevertheless, it can be understood (and will not surprise the person skilled in the art) that the charge in question may contain glass and/or glass-ceramic cullet. Said glasses are particularly advantageous in that:
they present advantageous devitrification properties, in particular compatible with using forming methods involving rolling, floating, and pressing. Said glasses present a low liquidus temperature (<1400° C.) and high viscosity at the liquidus (>400 Pa.s, preferably >700 Pa.s); and/or, and advantageously and
they present low high-temperature viscosity (T_{30 Pa.s}≤1640° C., advantageously ≤1630° C.).

It should also be observed that it is possible to obtain the glass-ceramics of the present application (from said precursor glasses) by using ceramming (crystallization) thermal cycles of short duration (<3 hr), preferably of very short duration (<1 hr), and that the resistivity of said precursor glasses is low (resistivity less than 50 Ω.cm, preferably less than 20 Ω.cm, at a viscosity of 30 Pa.s).

It is particularly emphasized that the liquidus temperature is low, that viscosity at the liquidus is high, and that viscosity at high temperature is low (see below).

In its last aspect, the present application provides a method of preparing an article constituted at least in part by a glass-ceramic of the present application, as described above.

Said method is a method by analogy.

In conventional manner, said method comprises heat treatment of a charge of vitrifiable raw materials (it being understood that such a vitrifiable charge may contain glass and/or glass-ceramic cullet (see above)) under conditions that ensure melting and fining in succession, followed by shaping the fined molten precursor glass (said shaping possibly being performed by rolling, by pressing, or by floating), followed by ceramming (or crystallization) thermal treatment of the shaped refined molten precursor glass.

Table I below specifies raw materials usually used in the charges of vitrifiable raw materials to have each one of the desired oxides present in the composition of precursor glasses and corresponding glass-ceramics. This list is in no way exhaustive.

TABLE I

| Oxide | Used raw materials |
|---|---|
| SiO₂ | Quartz sand or silica sand, spodumene, |
| | petalite |
| Al₂O₃ | Hydrated alumina, calcined alumina, |
| | spodumene, petalite, aluminum |
| | metaphosphate |
| Li₂O | Spodumene, petalite, lithium carbonate, |
| | lithium feldspar |
| P₂O₅ | Aluminum metaphosphate, sodium |
| | phosphate, barium phosphate, calcium |
| | phosphate |
| CaO | Dolomite, calcium carbonate, calcium |
| | phosphate |
| MgO | Dolomite, magnesium oxide |
| BaO | Barium carbonate, barium nitrate, |
| | barium phosphate |
| SrO | Strontium carbonate |
| ZnO | Zinc oxide |
| TiO₂ | Rutile, titanium oxide |
| ZrO₂ | Zirconium silicate, zirconium oxide |
| Na₂O | Feldspar, sodium nitrate, sodium |
| | phosphate, sodium carbonate |
| K₂O | Feldspar, potassium nitrate, potassium |
| | carbonate |
| SnO₂ | Tin oxide |
| V₂O₅ | Vanadium oxide |
| Fe₂O₃ | Iron oxide |
| Cr₂O₃ | Chromite, chromium oxide |

Each one of the used raw material is able to bring impurities which are taken into account in the calculation of quantities of different raw materials constituting the vitrifiable mixture (charge). For example, spodumene contains, depending on its source, variable contents in Li₂O, SiO₂ and Al₂O₃ as well impurities such as Na₂O, K₂O, Fe₂O₃ and P₂O₅. Li₂O is usually brought with at least one of the following raw materials: spodumene, petalite, lithium carbonate, lithium feldspar or a mixture thereof. In a preferred manner, Li₂O is only brought by spodumene (this is the case for the following examples and comparative examples (see tables III and IV)).

Fining is usually carried out at a temperature superior to 1600° C.

The ceramming thermal treatment generally comprises two steps: a nucleation step and another step of growing the crystals of the β-quartz solid solution. Nucleation generally takes place in the temperature range 650° C. to 830° C. and crystal growth in the temperature range 850° C. to 950° C. Concerning the duration of each of these steps, mention may be made in entirely non-limiting manner of about 5 minutes (min) to 60 min for nucleation and about 5 min to 30 min for crystal growth. The person skilled in the art knows how to optimize, more particularly with reference to the desired transparency, the temperatures and the durations of these two steps as a function of the composition of the precursor glasses.

Said method of preparing an article, constituted at least in part of a glass-ceramic of the present application thus comprises in succession:
melting a charge of vitrifiable raw materials, followed by fining the resulting molten glass;
cooling the resulting refined molten glass and simultaneously shaping it to the shape desired for the intended article; and
applying ceramming thermal treatment to said shaped glass.

The two successive steps of obtaining a shaped refined glass (precursor of the glass-ceramic) and ceramming said shaped refined glass may be performed immediately one after the other, or they may be spaced apart in time (on a single site or on different sites).

In characteristic manner, the charge of vitrifiable raw materials has a composition that makes it possible to obtain a glass-ceramic of the present application, thus presenting the composition by weight as specified above (advantageously including SnO₂ as a fining agent, (in the absence of As₂O₃ and Sb₂O₃ (see above)), very advantageously SnO₂ as single fining agent (generally 0.05% to 0.6% by weight of SnO₂, and more particularly 0.15% to 0.4% by weight of SnO₂)). The ceramming performed on the glass obtained from such a charge is entirely conventional. It is mentioned above that said ceramming may be obtained in a short length of time (<3 hr), or indeed in a very short length of time (<1 hr).

In the context of preparing an article, such as a cooktop, when the precursor glass has been obtained by rolling or floating, it is generally cut before the ceramming treatment (ceramming cycle). It is generally also formed and decorated. Such forming and decorating steps may be performed before or after the ceramming thermal treatment. By way of example, the decorating may be performed by screen-printing.

The present application is illustrated below by the following examples and comparative examples. Although the examples below describe laboratory experiments only, the characteristics of the glasses and glass-ceramics that are given show that these materials can be produced at an industrial scale.

### EXAMPLES

To produce batches of 1 kilogram (kg) of precursor glass, raw materials, in the proportions (proportions expressed by weight percentages of oxides) specified in the first portion of the tables below (table III and table IV, said tables III and IV spreading over several pages) were mixed together carefully.

The used raw material mixtures, for obtaining 1 kg of each one of the precursors glasses of examples 2, 13 and 23 of the following table III (taken for illustration), said glasses having the compositions (expressed in weight percentages) indicated in said table III, are hereafter specified in table II. The weight of each material is expressed in grams (g).

TABLEAU II

| Raw materials | Example | Example | Example |
|---|---|---|---|
| (weight (g)) | 2 | 13 | 23 |
| Quartz sand | 399.7 | 416.2 | 420.6 |
| Calcined alumina | 90.8 | 94.2 | 94.1 |
| Spodumene | 342.6 | 316.7 | 316.6 |
| Magnesium oxide | 11.8 | 8.1 | 4.9 |
| Zinc oxide | 19.6 | 31.9 | 31.9 |
| Barium nitrate | 46.9 | 41.7 | 41.6 |
| Dolomite | 11.2 | 11.6 | 11.8 |
| Rutile | 30.6 | 27.5 | 29.3 |
| Zirconium oxide | 12.9 | 17.0 | 14.2 |
| Feldspar | 47.7 | 47.2 | 47.2 |
| Tin oxide | 3.0 | 3.0 | 3.0 |
| Iron oxide | 0.3 | 0.3 | 0.3 |
| Vanadium oxide | 0.1 | 0.2 | 0.2 |
| Chromite | 0.6 | 0.6 | 0.6 |

The mixtures were placed for melting in crucibles made of platinum. The crucibles containing said mixtures were then placed in a furnace preheated to 1550° C. The furnace was heated with MoSi electrodes. The crucibles were subjected therein to a melting cycle of the following type:
hold at 1550° for 30 minutes (min);
raise temperature from 1550° C. to 1650° C. in 1 hr; and
hold at 1650° C. for 5 hr 30 min.

The crucibles were then extracted from the furnace and the molten glass was poured onto a preheated steel plate. It was rolled to have a thickness of 6 mm. Glass plates were thus obtained. They were annealed at 650° C. for 1 hr and subsequently cooled down slowly.

The properties of the resulting glasses are given in the second portion of the tables below.

Viscosities were measured using a rotational viscometer (Gero).

T_{30 Pa.s} (° C.) corresponds to the temperature at which the viscosity of the glass was 30 Pa.s.

T_{liq} (° C.) is the liquidus temperature. The liquidus temperature is given by a range of temperatures and associated viscosities: the highest temperature corresponds to the minimum temperature at which no crystal was observed, the lowest temperature corresponds to the maximum temperature at which crystals were observed. The experiments were carried out on precursor glass volumes of about 0.5 cubic centimeters (cm³) that were held for 17 h at the temperature of the test and the observations were performed by optical microscopy. The phase of the observed crystals is given in the tables below.

The resistivity of glass was measured while measuring viscosity. The table gives the resistivity measured at the temperature for which the viscosity was 30 Pa.s.

The ceramming cycle performed in a static furnace (in an atmosphere of ambient air) is set out below:
rapid temperature rise up to 500° C.;
temperature rise from 500° C. to 650° C. at a rate of 23° C./min;
temperature rise from 650° C. to 820° C. at a rate of 6.7° C./min;
temperature rise from 820° C. to 920° C. at a rate of 15° C./min;
holding this temperature Tmax (=920° C.) for 7 min;
cooling down to 850° C. at 35° C./min;
cooling down to ambient temperature as a function of the inertia of the furnace.

The properties of the glass-ceramics obtained are given in the last portion of the tables below.

These glass-ceramics contain a solid solution of β-quartz as the main crystalline phase (as verified by X-ray diffraction).

The coefficients of thermal expansion (CTEs) (from 25° C. to 450° C.=CTE_{(25-450° C.)} and also from 25° C. to 700° C.=CTE_{(25-700° C.)}) were measured using a high-temperature dilatometer (DIL 420C, Netzsch) heating at a rate of 3° C./min, on bar-shaped glass-ceramic samples.

On polished samples having a thickness of 4 mm, total and diffuse transmission measurements were performed using a Varian spectrophotometer (model Cary 500 Scan), fitted with an integrating sphere. On the basis of these measurements, the integrated transmission (Y (%)) in the visible range (380 mm to 780 mm) and the level of haze (diffusion (%)) were calculated using the standard ASTM D 1003-13 (with D65 illuminant and 2° observer). A value of Y that is below 10% is recommended in order to hide the induction heating elements and other technical components arranged under the cooktop. A level of haze of less than 2% is recommend in order to ensure good visibility of the red light emitted by the LEDs that are generally arranged under the cooktop. Transmission values (at 625 nm (T_{625 nm}) and at 950 nm (T_{950 nm})) are also specified in the tables.

### Examples 1 to 26

### (In Table III: IIIA to IIIG) Illustrate the Present Application

Examples 1 to 4 are preferred because of the particularly advantageous properties of the precursor glass: see the values given for high-temperature viscosity (T_{300 Pa.s}<1630° C.) and for liquidus viscosity (>700 Pa.s).

Examples 4 and 11 show the advantage of having P₂O₅ present in the composition of the precursor glass. This presence leads to a reduction in the liquidus temperature (about −15° C.) and consequently to an increase in viscosity at the liquidus temperature (+200 Pa.s).

The precursor glasses of Examples 5 to 15 present preferred values for viscosity at high temperature (<1630° C.).

The precursor glasses of Examples 16 to 20 present preferred values for viscosity at the liquidus (>700 Pa.s).

Examples 24 to 26 show the use of SrO in complement to BaO.

Examples A to E (in Tables IVA and IVB) are comparative examples.

In comparative example A, the content of SiO₂ is high (67.88%). The high-temperature viscosity is too high. It would be particularly difficult to manage melting and fining said precursor glass.

In comparative example B, the contents of SiO₂ and of BaO are high (respectively 67.74% and 4.25%). The high-temperature viscosity is too high. It would be difficult to manage melting and fining said precursor glass.

In comparative example C, the content of MgO is too high (1.74%) and the ratio (0.74 MgO+0.19 BaO+0.29 SrO+0.53 CaO+0.48 Na₂O+0.32 K₂O)/Li₂O is greater than 0.90. Consequently the CTE of the glass-ceramic is too high. Said glass-ceramic is therefore not suitable to be the material for making cooktops that are to be used with (conventional) induction heating elements.

In comparative example D, the ZnO content is too high. Consequently, the viscosity at the liquidus of the precursor glass is too low.

In comparative example E the ratio (0.74 MgO+0.19 BaO+0.29 SrO+0.53 CaO+0.48 Na₂O+0.32 K₂O)/Li₂O is greater than 0.90. Consequently the CTE of the glass-ceramic is too high.

TABLE IIIA

| Examples | | | | |
|---|---|---|---|---|
| (wt %) | 1 | 2 | 3 | 4 |
| SiO₂ | 66.98 | 66.98 | 65.75 | 65.06 |
| P₂O₅ | 0.04 | 0.04 | 1.14 | 2.11 |
| Al₂O₃ | 18.92 | 18.86 | 19.64 | 18.81 |
| Li₂O | 2.53 | 2.48 | 2.82 | 2.66 |
| MgO | 1.34 | 1.34 | 0.30 | 0.33 |
| ZnO | 1.85 | 1.80 | 2.27 | 2.96 |
| BaO | 2.48 | 2.76 | 2.09 | 2.42 |
| CaO | 0.45 | 0.46 | 0.33 | 0.47 |
| TiO₂ | 2.73 | 2.89 | 2.93 | 2.79 |
| ZrO₂ | 1.44 | 1.18 | 1.19 | 1.12 |
| Na₂O | 0.61 | 0.60 | 0.88 | 0.66 |
| K₂O | 0.17 | 0.17 | 0.17 | 0.15 |
| SnO₂ | 0.28 | 0.29 | 0.30 | 0.28 |
| Fe₂O₃ | 0.13 | 0.10 | 0.12 | 0.12 |
| V₂O₅ | 0.03 | 0.03 | 0.04 | 0.04 |
| Cr₂O₃ | 0.02 | 0.02 | 0.03 | 0.02 |
| (0.74 MgO + 0.19 BaO + 0.29 SrO + 0.53 | 0.81 | 0.85 | 0.45 | 0.50 |
| CaO + 0.48 Na₂O + 0.32 K₂O)/Li₂O | | | | |

Precursor glass properties

| | | | | |
|---|---|---|---|---|
| T_{(30Pa·s)} (° C.) | 1623 | 1627 | 1628 | 1624 |
| Resistivity at 30 Pa · s (Ω · cm) | 5.2 | 5.2 | 3.5 | 4.1 |
| T_{liq} (° C.) | 1309-1334 | 1311-1328 | 1326-1339 | 1322-1339 |
| Viscosity at T_{liq} (Pa · s) | 810-1170 | 900-1170 | 740-900 | 750-970 |
| Crystalline phase devitrifying at T_{liq} | spinel + | spinel | spinel | Spinel |
| | zircon | | | |

Glass-ceramic properties

| | | | | |
|---|---|---|---|---|
| CTE_{(25-700°C.)} (×10⁻⁷ K⁻¹) | 12.0 | 13.1 | 5.6 | 3.3 |
| CTE_{(25-450°C.)} (×10⁻⁷ K⁻¹) | 11.7 | 12.9 | 4.9 | 3.1 |
| Y (%) | 5.6 | 2.4 | 1.5 | 0.9 |
| Diffusion (%) | 0.5 | 0.4 | 0.6 | 1.0 |
| T₆₂₅ₙₘ (%) | 14.0 | 6.6 | 4.7 | 2.9 |
| T₉₅₀ₙₘ (%) | 67 | 66 | 65 | 60 |

TABLE IIIB

| Examples | | | | |
|---|---|---|---|---|
| (wt %) | 5 | 6 | 7 | 8 |
| SiO₂ | 66.60 | 66.92 | 65.07 | 66.67 |
| P₂O₅ | 0.05 | 0.05 | 2.12 | 0.05 |
| Al₂O₃ | 19.95 | 18.83 | 18.69 | 18.53 |
| Li₂O | 2.89 | 2.59 | 2.61 | 2.75 |
| MgO | 0.95 | 0.45 | 0.45 | 0.44 |
| ZnO | 2.23 | 3.05 | 2.95 | 2.11 |
| BaO | 1.83 | 2.42 | 2.38 | 3.89 |
| CaO | 0.49 | 0.47 | 0.47 | 0.48 |
| TiO₂ | 2.70 | 2.67 | 2.66 | 2.61 |
| ZrO₂ | 1.46 | 1.26 | 1.29 | 1.25 |
| Na₂O | 0.23 | 0.65 | 0.66 | 0.60 |
| K₂O | 0.14 | 0.15 | 0.17 | 0.17 |
| SnO₂ | 0.29 | 0.28 | 0.29 | 0.29 |
| Fe₂O₃ | 0.12 | 0.15 | 0.13 | 0.10 |
| V₂O₅ | 0.04 | 0.04 | 0.04 | 0.04 |
| Cr₂O₃ | 0.03 | 0.02 | 0.02 | 0.02 |
| (0.74 MgO + 0.19 BaO + 0.29 SrO + 0.53 | 0.51 | 0.54 | 0.54 | 0.60 |
| CaO + 0.48 Na₂O + 0.32 K₂O)/Li₂O | | | | |

Precursor glass properties

| | | | | |
|---|---|---|---|---|
| T_{(30Pa·s)} (° C.) | 1621 | 1629 | 1625 | 1620 |
| Resistivity at 30 Pa · s (Ω · cm) | 4.1 | 5 | 4.7 | 4.2 |
| T_{liq} (° C.) | 1328-1353 | 13474363 | 1345-1361 | 1330-1346 |
| Viscosity at T_{liq} (Pa · s) | 590-860 | 540-690 | 520-660 | 630-800 |
| Crystalline phase devitrifying at T_{liq} | mullite + | spinel | spinel | zircon |
| | spinel | | | |

Glass-ceramic properties

| | | | | |
|---|---|---|---|---|
| CTE_{(25-700°C.)} (×10⁻⁷ K⁻¹) | 4.9 | 4.7 | 3.7 | 7.2 |
| CTE_{(25-450°C.)} (×10⁻⁷ K⁻¹) | 3.2 | 4.0 | 3.4 | 6.2 |
| Y (%) | — | 5.3 | 1.2 | — |
| Diffusion (%) | — | 0.3 | 0.7 | — |
| T₆₂₅ₙₘ (%) | — | 13.8 | 3.9 | — |
| T₉₅₀ₙₘ (%) | — | 64 | 61 | — |

TABLE IIIC

| Examples | | | | |
|---|---|---|---|---|
| (wt %) | 9 | 10 | 11 | 12 |
| SiO₂ | 66.77 | 66.92 | 66.88 | 65.67 |
| P₂O₅ | 0.05 | 0.04 | 0.05 | 1.12 |
| Al₂O₃ | 18.43 | 18.44 | 18.93 | 19.62 |
| Li₂O | 2.77 | 2.30 | 2.62 | 2.83 |
| MgO | 0.53 | 1.15 | 0.34 | 0.33 |
| ZnO | 2.03 | 2.95 | 2.99 | 2.17 |
| BaO | 3.84 | 2.45 | 2.45 | 2.47 |
| CaO | 0.47 | 0.47 | 0.49 | 0.49 |
| TiO₂ | 2.62 | 2.80 | 2.84 | 2.89 |
| ZrO₂ | 1.26 | 1.21 | 1.13 | 1.16 |
| Na₂O | 0.61 | 0.66 | 0.66 | 0.61 |
| K₂O | 0.17 | 0.17 | 0.16 | 0.16 |
| SnO₂ | 0.29 | 0.28 | 0.29 | 0.29 |
| Fe₂O₃ | 0.10 | 0.11 | 0.11 | 0.12 |
| V₂O₅ | 0.04 | 0.03 | 0.04 | 0.04 |
| Cr₂O₃ | 0.02 | 0.02 | 0.02 | 0.03 |
| (0.74 MgO + 0.19 BaO + 0.29 SrO + 0.53 | 0.62 | 0.84 | 0.51 | 0.47 |
| CaO + 0.48 Na₂O + 0.32 K₂O)/Li₂O | | | | |

Precursor glass properties

| | | | | |
|---|---|---|---|---|
| T_{(30Pa·s)} (° C.) | 1627 | 1620 | 1626 | 1621 |
| Resistivity at 30 Pa · s (Ω · cm) | 4.4 | 4.7 | 4.2 | 3.6 |
| T_{liq} (° C.) | 1330-1346 | 13464365 | 1339-1353 | 1325-1342 |
| Viscosity at T_{liq} (Pa · s) | 640-820 | 470-620 | 590-720 | 680-880 |
| Crystalline phase devitrifying at T_{liq} | zircon | spinel | spinel | spinel |

Glass-ceramic properties

| | | | | |
|---|---|---|---|---|
| CTE_{(25-700°C.)} (×10⁻⁷ K⁻¹) | 7.3 | 10.3 | 4.3 | 4.5 |
| CTE_{(25-450°C.)} (×10⁻⁷ K⁻¹) | 6.4 | 10.1 | 3.5 | 3.5 |
| Y (%) | — | — | 2.8 | 1.7 |
| Diffusion (%) | — | — | 0.4 | 0.4 |
| T₆₂₅ₙₘ (%) | — | — | 7.9 | 5.2 |
| T₉₅₀ₙₘ (%) | — | — | 66 | 64 |

TABLE IIID

| Examples | | | | |
|---|---|---|---|---|
| (wt %) | 13 | 14 | 15 | 16 |
| SiO₂ | 67.04 | 66.72 | 65.40 | 67.08 |
| P₂O₅ | 0.04 | 0.04 | 1.12 | 0.05 |
| Al₂O₃ | 18.48 | 19.54 | 20.54 | 19.15 |
| Li₂O | 2.33 | 2.46 | 2.88 | 2.44 |
| MgO | 0.98 | 1.21 | 0.39 | 1.19 |
| ZnO | 2.99 | 1.79 | 2.59 | 1.78 |
| BaO | 2.42 | 2.45 | 0.01 | 2.49 |
| CaO | 0.46 | 0.47 | 1.49 | 0.47 |
| TiO₂ | 2.57 | 2.91 | 2.93 | 2.95 |
| ZrO₂ | 1.42 | 1.20 | 1.34 | 1.19 |
| Na₂O | 0.65 | 0.60 | 0.63 | 0.59 |
| K₂O | 0.16 | 0.17 | 0.16 | 0.18 |
| SnO₂ | 0.29 | 0.28 | 0.30 | 0.28 |
| Fe₂O₃ | 0.12 | 0.11 | 0.15 | 0.11 |
| V₂O₅ | 0.03 | 0.03 | 0.04 | 0.03 |
| Cr₂O₃ | 0.02 | 0.02 | 0.03 | 0.02 |
| (0.74 MgO + 0.19 BaO + 0.29 SrO + 0.53 | 0.77 | 0.79 | 0.50 | 0.80 |
| CaO + 0.48 Na₂O + 0.32 K₂O)/Li₂O | | | | |

Precursor glass properties

| | | | | |
|---|---|---|---|---|
| T_{(30Pa·s)} (° C.) | 1620 | 1622 | 1612 | 1640 |
| Resistivity at 30 Pa · s (Ω · cm) | 5.6 | 4.7 | 3.6 | 4.3 |
| T_{liq} (° C.) | 1339-1353 | 1334-1346 | 1326-1342 | 1330-1352 |
| Viscosity at T_{liq} (Pa · s) | 570-670 | 670-790 | 600-760 | 730-1010 |
| Crystalline phase devitrifying at T_{liq} | spinel + | mullite | spinel | spinel + |
| | zircon | | | mullite |

Glass-ceramic properties

| | | | | |
|---|---|---|---|---|
| CTE_{(25-700°C.)} (×10⁻⁷ K⁻¹) | 9.2 | 13.2 | 2.9 | 12.6 |
| CTE_{(25-450°C.)} (×10⁻⁷ K⁻¹) | 8.8 | 12.9 | 2.4 | 12.6 |
| Y (%) | 5.5 | 4.6 | 1.2 | 3.8 |
| Diffusion (%) | 0.4 | 0.6 | 1.2 | 0.6 |
| T₆₂₅ₙₘ (%) | 14.4 | 11.2 | 3.8 | 9.7 |
| T₉₅₀ₙₘ (%) | 65 | 68 | 62 | 67 |

TABLE IIIE

| Examples | | | | |
|---|---|---|---|---|
| (wt %) | 17 | 18 | 19 | 20 |
| SiO₂ | 67.29 | 65.22 | 65.04 | 64.87 |
| P₂O₅ | 0.04 | 2.13 | 2.17 | 2.13 |
| Al₂O₃ | 18.98 | 19.52 | 19.36 | 19.45 |
| Li₂O | 2.45 | 2.80 | 2.78 | 2.80 |
| MgO | 1.20 | 0.32 | 0.32 | 0.33 |
| ZnO | 1.79 | 1.79 | 2.11 | 2.16 |
| BaO | 2.45 | 2.46 | 2.44 | 2.46 |
| CaO | 0.47 | 0.48 | 0.50 | 0.50 |
| TiO₂ | 2.92 | 2.87 | 2.88 | 2.89 |
| ZrO₂ | 1.20 | 1.18 | 1.15 | 1.15 |
| Na₂O | 0.60 | 0.60 | 0.61 | 0.62 |
| K₂O | 0.17 | 0.17 | 0.16 | 0.17 |
| SnO₂ | 0.28 | 0.29 | 0.29 | 0.30 |
| Fe₂O₃ | 0.11 | 0.11 | 0.13 | 0.11 |
| V₂O₅ | 0.03 | 0.04 | 0.04 | 0.04 |
| Cr₂O₃ | 0.02 | 0.02 | 0.02 | 0.02 |
| (0.74 MgO + 0.19 BaO + 0.29 SrO + 0.53 | 0.79 | 0.46 | 0.47 | 0.47 |
| CaO + 0.48 Na₂O + 0.32 K₂O)/Li₂O | | | | |

Precursor glass properties

| | | | | |
|---|---|---|---|---|
| T_{(30Pa·s)} (° C.) | 1638 | 1640 | 1635 | 1631 |
| Resistivity at 30 Pa · s (Ω · cm) | — | 3.9 | 4.2 | 4.2 |
| T_{liq} (° C.) | 1330-1350 | 1294-1320 | 13094335 | 1311-1327 |
| Viscosity at T_{liq} (Pa · s) | 740-1000 | 1170-1770 | 860-1270 | 920-1180 |
| Crystalline phase devitrifying at T_{liq} | spinel | spinel | spinel | spinel |

Glass-ceramic properties

| | | | | |
|---|---|---|---|---|
| CTE_{(25-700°C.)} (×10⁻⁷ K⁻¹) | 12.3 | 4.8 | 4.2 | 4.1 |
| CTE_{(25-450°C.)} (×10⁻⁷ K⁻¹) | 12.3 | 4.3 | 3.7 | 3.6 |
| Y (%) | 3.2 | 1.3 | 1.0 | |
| Diffusion (%) | 0.6 | 0.8 | 0.7 | |
| T₆₂₅ₙₘ (%) | 8.4 | 4.0 | 3.2 | — |
| T₉₅₀ₙₘ (%) | 64 | 64 | 61 | — |

TABLE IIIF

| Examples | | | |
|---|---|---|---|
| (wt %) | 21 | 22 | 23 |
| SiO₂ | 67.01 | 66.72 | 67.27 |
| P₂O₅ | 0.05 | 0.05 | 0.04 |
| Al₂O₃ | 18.88 | 18.40 | 18.50 |
| Li₂O | 2.68 | 2.60 | 2.30 |
| MgO | 0.31 | 0.46 | 0.71 |
| ZnO | 2.93 | 2.94 | 3.01 |
| BaO | 2.42 | 2.96 | 2.45 |
| CaO | 0.48 | 0.71 | 0.48 |
| TiO₂ | 2.69 | 2.65 | 2.77 |
| ZrO₂ | 1.29 | 1.25 | 1.19 |
| Na₂O | 0.64 | 0.65 | 0.67 |
| K₂O | 0.15 | 0.15 | 0.17 |
| SnO₂ | 0.28 | 0.28 | 0.28 |
| Fe₂O₃ | 0.13 | 0.12 | 0.11 |
| V₂O₅ | 0.04 | 0.04 | 0.03 |
| Cr₂O₃ | 0.02 | 0.02 | 0.02 |
| (0.74 MgO + 0.19 BaO + | 0.48 | 0.63 | 0.70 |
| 0.29 SrO + 0.53 CaO + 0.48 | | | |
| Na₂O + 0.32 K₂O)/Li₂O | | | |

Precursor glass properties

| | | | |
|---|---|---|---|
| T_{(30Pa·s)} (° C.) | 1637 | 1635 | 1640 |
| Resistivity at 30 Pa · s (Ω · cm) | 3.9 | 3.6 | 5.4 |
| T_{liq} (° C.) | 1347-1364 | 1346-1363 | 1339-1357 |
| Viscosity at T_{liq} (Pa · s) | 590-750 | 570-730 | 660-850 |
| Crystalline phase devitrifying at T_{liq} | spinel | spinel | spinel |

Glass-ceramic properties

| | | | |
|---|---|---|---|
| CTE_{(25-700°C.)} (×10⁻⁷ K⁻¹) | 3.4 | 5.6 | 8.1 |
| CTE_{(25-450°C.)} (×10⁻⁷ K⁻¹) | 2.6 | 4.8 | 7.8 |
| Y (%) | 4.6 | 2.1 | — |
| Diffusion (%) | 0.7 | 0.7 | — |
| T₆₂₅ₙₘ (%) | 12.3 | 6.4 | — |
| T₉₅₀ₙₘ (%) | 66 | 63 | — |

TABLE IIIG

| Examples | | | |
|---|---|---|---|
| (wt %) | 24 | 25 | 26 |
| SiO₂ | 66.66 | 66.24 | 64.88 |
| P₂O₅ | 0.04 | 0.04 | 2.10 |
| Al₂O₃ | 19.31 | 19.66 | 19.11 |
| Li₂O | 2.50 | 2.56 | 2.67 |
| MgO | 1.37 | 1.41 | 0.35 |
| ZnO | 1.88 | 2.04 | 3.06 |
| BaO | 1.40 | 0.004 | 1.25 |
| SrO | 0.89 | 1.89 | 0.73 |
| CaO | 0.45 | 0.46 | 0.47 |
| TiO₂ | 2.94 | 2.97 | 2.82 |
| ZrO₂ | 1.32 | 1.48 | 1.24 |
| Na₂O | 0.61 | 0.62 | 0.67 |
| K₂O | 0.17 | 0.17 | 0.17 |
| SnO₂ | 0.29 | 0.28 | 0.29 |
| Fe₂O₃ | 0.11 | 0.13 | 0.12 |
| V₂O₅ | 0.03 | 0.02 | 0.04 |
| Cr₂O₃ | 0.03 | 0.03 | 0.03 |
| (0.74 MgO + 0.19 BaO + | 0.85 | 0.85 | 0.50 |
| 0.29 SrO + 0.53 CaO + 0.48 | | | |
| Na₂O + 0.32 K₂O)/Li₂O | | | |

Precursor glass properties

| | | | |
|---|---|---|---|
| T_{(30Pa·s)} (° C.) | 1631 | 1625 | 1635 |
| Resistivity at 30 Pa · s (Ω · cm) | — | 4.1 | 3.6 |
| T_{liq} (° C.) | 1317-1335 | 1313-1332 | 1330-1344 |
| Viscosity at T_{liq} (Pa · s) | 840-1100 | 840-1120 | 780-960 |
| Crystalline phase devitrifying at T_{liq} | spinel | spinel | spinel |

Glass-ceramic properties

| | | | |
|---|---|---|---|
| CTE_{(25-700°C.)} (×10⁻⁷ K⁻¹) | 12.7 | 12.3 | 3.5 |
| CTE_{(25-450°C.)} (×10⁻⁷ K⁻¹) | 12.5 | 12.1 | 3.2 |
| Y (%) | 2.4 | 2.3 | 0.9 |
| Diffusion (%) | 0.2 | 0.1 | 0.1 |
| T₆₂₅ₙₘ (%) | 6.7 | 6.4 | 3.0 |
| T₉₅₀ₙₘ (%) | 66 | 65 | 62 |

TABLE IV A

| Comparative examples | | | | |
|---|---|---|---|---|
| (wt %) | A | B | C | D |
| SiO₂ | 67.88 | 67.74 | 66.74 | 66.02 |
| P₂O₅ | 0.04 | 0.06 | 0.03 | 0.06 |
| Al₂O₃ | 19.00 | 18.46 | 19.08 | 19.40 |
| Li₂O | 2.27 | 2.47 | 2.32 | 2.80 |
| MgO | 0.90 | 0.24 | 1.74 | 0.31 |
| ZnO | 1.83 | 1.23 | 1.83 | 3.30 |
| BaO | 2.44 | 4.25 | 2.47 | 2.42 |
| CaO | 0.47 | 0.45 | 0.45 | 0.48 |
| TiO₂ | 2.73 | 2.80 | 2.91 | 2.83 |
| ZrO₂ | 1.26 | 1.11 | 1.21 | 1.04 |
| Na₂O | 0.59 | 0.57 | 0.60 | 0.68 |
| K₂O | 0.17 | 0.21 | 0.17 | 0.15 |
| SnO₂ | 0.27 | 0.27 | 0.29 | 0.29 |
| Fe₂O₃ | 0.10 | 0.07 | 0.11 | 0.15 |
| V₂O₅ | 0.03 | 0.05 | 0.03 | 0.04 |
| Cr₂O₃ | 0.02 | 0.02 | 0.02 | 0.03 |
| (0.74 MgO + 0.19 BaO + 0.29 SrO + 0.53 | 0.76 | 0.63 | 1.01 | 0.46 |
| CaO + 0.48 Na₂O + 0.32 K₂O)/Li₂O | | | | |

Precursor glass properties

| | | | | |
|---|---|---|---|---|
| T_{(30Pa·s)} (° C.) | 1656 | 1681 | 1619 | 1600 |
| Resistivity at 30 Pa · s (Ω · cm) | 5.5 | 5.4 | 5.6 | 4.4 |
| T_{liq} (° C.) | 1361-1372 | 1296-1325 | 1328-1346 | 1362-1372 |
| Viscosity at T_{liq} (Pa · s) | 750-880 | 1700-2700 | 660-870 | 360-420 |
| Crystalline phase devitrifying at T_{liq} | mullite | zircon + | spinel + | spinel |
| | | mullite | mullite | |

Glass-ceramic properties

| | | | | |
|---|---|---|---|---|
| CTE_{(25-700°C.)} (×10⁻⁷ K⁻¹) | 11.1 | — | 14.6 | 2.7 |
| CTE_{(25-450°C.)} (×10⁻⁷ K⁻¹) | 10.8 | — | 14.4 | 1.3 |
| Y (%) | 7.9 | — | 1.9 | 0.9 |
| Diffusion (%) | 2.3 | — | 0.7 | 1.0 |
| T₆₂₅ₙₘ (%) | 17.4 | — | 5.3 | 2.8 |
| T₉₅₀ₙₘ (%) | 69 | — | 64 | 59 |

TABLE IV B

| Comparative examples | |
|---|---|
| (wt %) | E |
| SiO₂ | 66.44 |
| P₂O₅ | 0.03 |
| Al₂O₃ | 18.73 |
| Li₂O | 2.19 |
| MgO | 1.31 |
| ZnO | 1.65 |
| BaO | 3.46 |
| CaO | 1.07 |
| TiO₂ | 2.79 |
| ZrO₂ | 1.12 |
| Na₂O | 0.60 |
| K₂O | 0.17 |
| SnO₂ | 0.29 |
| Fe₂O₃ | 0.10 |
| V₂O₅ | 0.03 |
| Cr₂O₃ | 0.02 |
| (0.74 MgO + 0.19 BaO + 0.29 SrO + | 1.16 |
| 0.53 CaO + 0.48 Na₂O + 0.32 K₂O)/Li₂O | |

Precursor glass properties

| | |
|---|---|
| T_{(30Pa·s)} (° C.) | 1615 |
| Resistivity at 30 Pa · s (Ω · cm) | 5.7 |

Glass-ceramic properties

| | |
|---|---|
| CTE_{(25-700°C.)} (×10⁻⁷ K⁻¹) | 18.1 |
| CTE_{(25-450°C.)} (×10⁻⁷ K⁻¹) | 17.5 |
| Y (%) | 2.4 |
| Diffusion (%) | 0.7 |
| T₆₂₅ₙₘ (%) | 6.5 |
| T₉₅₀ₙₘ (%) | 65 |

1. A transparent glass-ceramic of lithium aluminosilicate type containing a solid solution of β-quartz as its main crystalline phase, the composition of which, expressed in percentages by weight of oxides, comprises:
63% to 67.5% of SiO₂;
18% to 21% of Al₂O₃;
2% to 2.9% of Li₂O;
0 to 1.5% of MgO;
1% to 3.2% of ZnO;
0 to 4% of BaO;
0 to 4% of SrO;
0 to 2% of CaO;
2% to 5% of TiO₂;
0 to 3% of ZrO₂;
0 to 1% of Na₂O;
0 to 1% of K₂O;
0 to 5% of P₂O₅;
with (0.74 MgO+0.19 BaO+0.29 SrO+0.53 CaO+0.48 Na₂O+0.32 K₂O)/Li₂O<0.9;
0 to 2% of at least one fining agent; and
0 to 2% of at least one coloring agent.

2. The glass-ceramic according to claim 1, wherein the composition comprises a content of Li20 that is less than or equal to 2.85%.

3. The glass-ceramic according to claim 1, wherein the composition comprises 1% to 3% of ZnO.

4. The glass-ceramic according to claim 1, wherein the composition comprises at least 0.5% of P₂O₅.

5. The glass-ceramic according to claim 1, wherein, except for inevitable traces, the composition does not contain any P₂O₅ and comprises 1% to 2.5% of ZnO.

6. The glass-ceramic according to claim 1, wherein, except for inevitable traces, the composition does not comprise any B₂O₃.

7. The glass-ceramic according to claim 1, wherein the composition, free from As₂O₃ and Sb₂O₃, except for inevitable traces, comprises SnO₂ as the at least one fining agent.

8. The glass-ceramic according to claim 1, wherein the composition contains V₂O₅ as coloring agent, alone or mixed with at least one other coloring agent selected from CoO, Cr₂O₃, and Fe₂O₃.

9. The glass-ceramic according to claim 1, having a coefficient of thermal expansion: CTE_{(25-450° C.)} lying in the range ±14×10⁻⁷K⁻¹.

10. A cooktop comprising, at least in part, a glass-ceramic according to claim 1.

11. A lithium aluminosilicate glass, precursor for the glass-ceramic according to claim 1, comprising a composition that makes it possible to obtain the glass-ceramic according to claim 1.

12. The glass according to claim 11, having a liquidus temperature of less than 1400° C. and a viscosity at the liquidus of more than 200 Pa.s.

13. A method of preparing the cooktop according to claim 10, comprising in succession:
melting a vitrifiable charge of raw materials, followed by fining the resulting molten glass;
cooling the resulting refined molten glass and simultaneously shaping it to the shape desired for the cooktop; and
applying ceramming heat treatment to the shaped glass;
wherein the vitrifiable charge of raw materials has a composition that makes it possible to obtain the glass-ceramic of claim 1.

14. The method according to claim 13, characterized in that the vitrifiable charge of raw materials, free from As₂O₃ and of Sb₂O₃, except for inevitable traces, contains 0.05% to 0.6% SnO₂ as fining agent.

15. The glass-ceramic according to claim 2, wherein the composition comprises a content of Li₂O from 2.20% to 2.85%.

16. The glass-ceramic according to claim 4, wherein the composition comprises from 1% to 3% P₂O₅.

17. The glass-ceramic according to claim 7, wherein the composition comprises 0.05% to 0.6% SnO₂.

18. The glass-ceramic according to claim 17, wherein the composition comprises 0.15% to 0.4% of SnO₂.

19. The glass-ceramic according to claim 9, having a coefficient of thermal expansion: CTE_{(25-450° C.)} lying in the range ±14×10⁻⁷K⁻¹.

20. The glass according to claim 12, having a viscosity of 30 Pa.s at less than 1640° C. (T₃₀ Pa.s<1640° C.).
